(19) United States
(12) Patent Application Publication
(10) Pub. No.: US 2013/0346328 A1
(43) Pub. Date: Dec. 26, 2013

(54) METHOD AND SYSTEM FOR ASSESSING COMPLIANCE RISK OF REGULATED INSTITUTIONS

(71) Applicant: Neighborbench LLC, Rockville, MD (US)

(72) Inventors: Kenneth Price AGLE, Mapleton, UT (US); Ken WOLFF, Rockville, MD (US); Eric HELFRICH, Baltimore, MD (US)

(73) Assignee: Neighborbench LLC, Rockville, MD (US)

(21) Appl. No.: 13/974,809

(22) Filed: Aug. 23, 2013

Related U.S. Application Data
(63) Continuation-in-part of application No. 13/743,813, filed on Jan. 17, 2013, now Pat. No. 8,543,444.
Application No. 13/743,813 is a continuation-in-part of application No. 13/278,627, filed on Oct. 21, 2011, now abandoned.

(51) Int. Cl. G06Q 30/00

(52) U.S. Cl. CPC G06Q 30/018
USPC 705/317

(57) ABSTRACT

A method for distributing requests for artifacts to a regulated institution for risk assessment includes: storing a client profile including a risk rating value corresponding to a risk that the related regulated institution will not be compliant with a set of regulations; identifying a plurality of artifacts to be provided by the regulated institution, each artifact including a frequency, a weight, one of a plurality of waves, and one of a plurality of categories; assigning a priority value to each of the categories; grouping each artifact into a plurality of buckets, each bucket including artifacts that include a common wave and a common category, and wherein the artifacts are evenly distributed into the buckets; and generating a request schedule, wherein the request schedule is a schedule for the distribution of requests for artifacts included in each bucket over a predetermined period of time.

### RELATED APPLICATIONS

This application claims the priority benefit of commonly assigned U.S. application Ser. No. 13/278,627, entitled “Method and System for Assessing Compliance Risk of Financial Institutions” by Kenneth Price Agle et al., filed Oct. 21, 2011, and U.S. Provisional Application No. 61/838,010, entitled “Method and System for Assessing Compliance Risk of Financial Institutions,” filed Jun. 21, 2013, which are herein incorporated by reference in their entirety.

### FIELD OF THE INVENTION

The present disclosure relates methods for assessing and managing risk in a financial institution associated with compliance. In particular, this disclosure relates to assessing and managing risk for an institution to be compliant with a set of regulations, and providing policies and procedures to follow to achieve or maintain compliance, including providing notifications to the institution.

### BACKGROUND OF THE INVENTION

In recent years, various institutions and other organizations have experienced heightened regulatory scrutiny, negative media attention, reputational damage, legal liability, and other sanctions for violations of compliance obligations. This, in turn, has given rise to an increased attention by regulators and the corresponding regulated institutions on the role of compliance. In addition, regulators have required these institutions to increase the amount of resources they devote to compliance risk management.

Compliance risk management has become more challenging as the number of compliance obligations has proliferated. For example, in the financial industry, regulations have expanded and increased the number of compliance obligations. Examples of proliferating regulators in the financial industry include the Anti-Money Laundering and Counter-Terrorist Financing Obligations of the USA PATRIOT ACT, the Bank Secrecy Act, and the Right to Financial Privacy Act. This has led to a number of regulated institutions employing a number of employees dedicated to ensuring that the institution is compliant with regulations. Conversely, some institutions choose to pay outside providers for assistance with compliance, incurring substantial costs in the process. For smaller institutions, such as many locally owned and operated small businesses, the time and expense necessary to employ full-time compliance personnel or hire an outside provider and keep up-to-date with regulations can be staggering. Even for larger businesses that may be able to afford employing full-time compliance personnel, the amount of work necessary to maintain compliance can be staggering without additional assistance.

Institutions have a need to better and more systematically manage their compliance obligations. This has proven difficult, as demonstrated by the large number of enforcement actions that have been brought in recent years against institutions and other organizations for failure to manage compliance risk. Current methods of managing compliance risk relate to using questionnaires and/or databases to summarize and assess risk based on information provided by the institution. This process makes it difficult for an institution to properly assess risk and, once risk is assessed, not only make changes to become compliant but to also ensure that the institution stays compliant and facilitates regulator visits. Other current methods of managing compliance risk relate to having onsite personnel review documents, policies, and procedures by using checklists and developing recommendation reports. Such a process is difficult for many institutions to implement, due to the expense and logistics involved with accommodating onsite personnel. These processes also suffer from a lack of communication and involvement with the institution itself.

What is missing from current approaches to compliance risk management is a method for assessing compliance risk that uses information from both publicly available sources and key employees of the institution to assess risk and also create a plan of policies and procedures for the institution to follow. Thus, a need exists for a system for assessing compliance risk using information from a publicly available source as well as information from a client questionnaire that is separated into role categories and answered by employees with areas of responsibility corresponding to the role categories.

### SUMMARY OF THE INVENTION

Systems and methods for assessing and managing compliance risk of a regulated institution, and for requesting artifacts from the regulated institution for assessment are disclosed herein.

It is noted initially that, as used herein, the term “institution” can include, for example, a bank (e.g., a national banks or a federal savings bank), a credit union, or any other institution that provides financial services for its clients or members (e.g., trust companies, mortgage loan companies, insurance companies, investment funds, etc.), a pharmaceutical company, a large drug manufacturer, research institutions or laboratories, investment institutions, or any other legal entity that is heavily regulated by a single or by multiple regulatory agencies or authorities. It is also noted that “regulation” refers to any form of regulation or supervision that an institution may be subject to. It can include, for example, governmental regulations (e.g., local, state, or federal) or non-governmental regulations, such as those imposed by a national association or the institution itself.

Exemplary embodiments of the present disclosure provide an advantageous feature by which an institution can achieve or maintain compliance with a set of regulations. A risk rating is assessed for an institution based on data obtained from publicly available sources and employee-given response to a questionnaire. Based on the assessed risk, a set of policies and procedures is created for the institution to implement in order to achieve or maintain compliance, and the institution is notified of the required policies and procedures. Media generated when the institution follows the policies and procedures is analyzed to reassess risk and update the necessary policies and procedures to be followed.

A method for distributing requests for artifacts to a regulated institution for risk assessment includes: storing, in a database, a client profile, wherein the client profile includes data related to a regulated institution including at least a risk rating value corresponding to a risk that the related regulated institution will not be compliant with a set of regulations; identifying, by a processing device, a plurality of artifacts to be provided by the regulated institution, wherein each artifact of the plurality of artifacts includes at least a frequency, a weight, one of a plurality of waves, and one of a plurality of categories; assigning, by the processing device, a priority value to each of the plurality of categories; grouping, by the processing device, each artifact of the plurality of artifacts into a plurality of buckets, wherein each bucket includes artifacts of the plurality of artifacts that include a common wave and a common category, and wherein the plurality of artifacts are evenly distributed into the plurality of buckets; and generating, by the processing device, a request schedule, wherein the request schedule is a schedule for the distribution of requests for artifacts included in each bucket of the plurality of buckets over a predetermined period of time.

A system for distributing artifacts to a regulated institution for risk assessment includes a database, a processing device, and a scheduling device. The database is configured to store a client profile, wherein the client profile includes data related to a regulated institution including at least a risk rating value corresponding to a risk that the related regulated institution will not be compliant with a set of regulations. The processing device configured to: identify a plurality of artifacts to be provided by the regulated institution, wherein each artifact of the plurality of artifacts includes at least a frequency, a weight, one of a plurality of waves, and one of a plurality of categories; assign a priority value to each of the plurality of categories; and group each artifact of the plurality of artifacts into a plurality of buckets, wherein each bucket includes artifacts of the plurality of artifacts that include a common wave and a common category, and wherein the plurality of artifacts are evenly distributed into the plurality of buckets. The scheduling device is configured to generate a request schedule, wherein the request schedule is a schedule for the distribution of requests for artifacts included in each bucket of the plurality of buckets over a predetermined period of time.

These and other features of the present disclosure will be readily appreciated by one of ordinary skill in the art from the following detailed description of various implementations when taken in connection with the accompanying drawings.

### BRIEF DESCRIPTION OF THE DRAWING FIGURES

FIG. 1 is a block diagram illustrating components of a system for assessing compliance risk according to an embodiment of the disclosed system.

FIGS. 2 and 3 are block diagrams illustrating alternative embodiments of a system for assessing compliance risk consistent with the present disclosure.

FIG. 4 is a flowchart illustrating a method for assessing compliance risk of a regulated institution according to an embodiment of the disclosed system.

FIG. 5 is a flowchart illustrating additional features of the method for assessing compliance risk of FIG. 4 according to an embodiment.

FIG. 6 is a flow diagram illustrating a process for distributing artifact requests to a regulated institution for compliance according to an embodiment.

FIG. 7 is a flowchart illustrating a method for distributing artifacts to a regulated institution for risk assessment accordance to an embodiment of the disclosed system.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

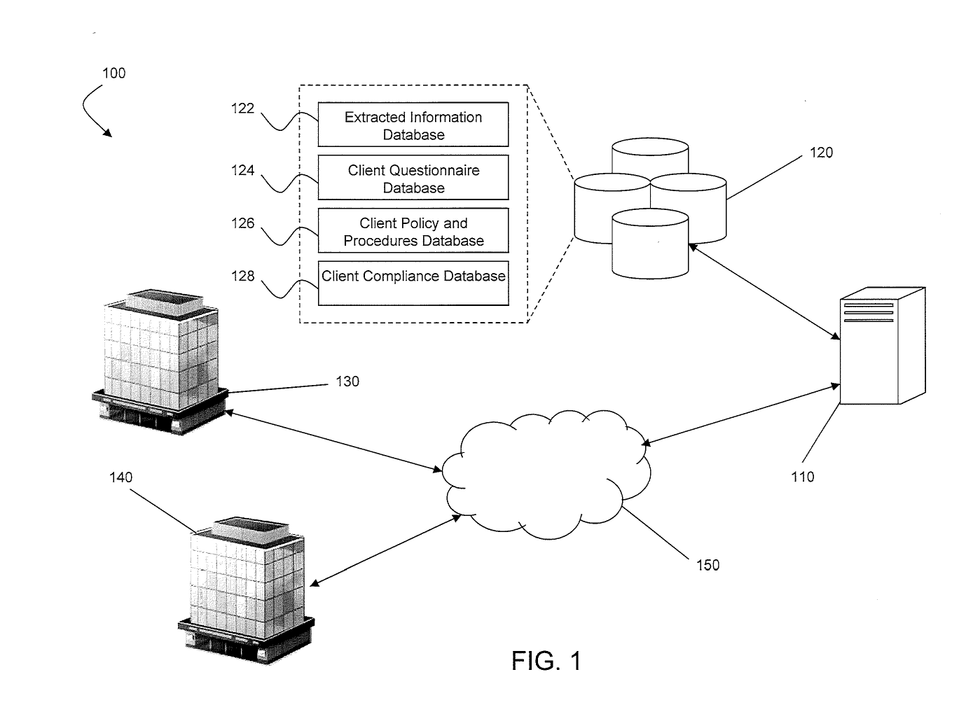

FIG. 1 is a block diagram illustrating components of a system 100 for assessing compliance risk according to an embodiment of the disclosed system. The system 100 includes a computer processing device 110, a plurality of databases 120, a client institution 130, and a source of publicly available information 140. The computer processing device 110, the client institution 130, and the publicly available source 140 are each connected via the network 150. The network 150 can be any suitable network configured to perform the features as disclosed herein. Suitable networks include, but are not limited to, a wide area network (WAN), local area network (LAN), the Internet, wireless network, landline, cable line, fiber-optic line, etc.

The computer processing device 110 is implemented in the system 100 for assessing the compliance risk of client institution 130. The computer processing device 110 is configured to have a communication path to and from the network 150. Types of communication paths utilized will be apparent to persons having skill in the relevant art(s). The computer processing device 110 is also configured to perform the functions additional functions as described below. The types of processing devices suitable for use as the computer processing device 110 include any device configured to perform the functions as discussed herein and will be apparent to persons having skill in the relevant art(s). For example, the computer processing device 110 can be a personal computer (PC), a server, or a plurality of servers.

The computer processing device 110 is connected to a plurality of databases 120. In FIG. 1 the connection between the computer processing device 110 and plurality of databases 120 is illustrated as being a serial connection. It will be apparent to persons having skill in the art that the connection can be performed in additional ways. For example, in one embodiment, the computer processing device 110 and plurality of databases 120 are connected through the network 150. The plurality of databases includes an extracted information database 122, client questionnaire database 124, client policy and procedures database 126, and client compliance database 128. It will be apparent to persons having skill in the art that these databases can be separate databases, or can all be implemented as a single database, either virtually or physically. Furthermore, the plurality of databases 120, while being illustrated in FIG. 1 as being external to computer processing device 110, can, in alternative embodiments, be implemented within the computer processing device 110. The type of database used may include a relational database management system (RDBMS). Methods of storing and accessing the information in the database will be apparent to persons having skill in the relevant art(s). For example, a query language can be used (e.g., Standardized Query Language (SQL) or QUEL).

The computer processing device 110 is configured to communicate with the publicly available source 140 via the network 150. The publicly available source 140 contains information on a plurality of regulated institutions. The publicly available source can include regulatory agencies (e.g., the Federal Deposit Insurance Corporation (FDIC) or National Credit Union Administration (NCUA), for example. In one exemplary embodiment, the publicly available source 140 publishes consolidated call reports that contain information on a plurality of institutions (e.g., FDIC and NCUA for financial institutions). The computer processing device 110 retrieves the information from the publicly available source 140 via the network 150 and stores the information in the extracted information database 122.

The client institution 130 is configured to communicate with the computer processing device 110 via network 150. The client institution 130 provides the computer processing device 110 with a list of employees and the area of responsibility for each employee on the list.

The computer processing device 110 creates a client questionnaire that is separated into a plurality of role categories. The plurality of role categories can include, for example, chief compliance officer, loan lead, deposit lead, advertising lead, and operations lead. The client questionnaire is then distributed to the client institution 130 with each employee on the list of employees receiving questions corresponding to the employee's area of responsibility. For example, the compliance officer of the client institution 130 will receive questions related of the chief compliance officer role category. It will be apparent to persons having skill in the relevant art that the role categories and distribution of the client questionnaire will vary depending on the client institution 130. For example, if the client institution 130 does not employ a compliance officer, then questions corresponding to the chief compliance officer role category may be distributed to a different employee, or split among multiple employees. The answers are then transmitted from the client institution 130 to the computer processing device 110, and are stored in the client questionnaire database 124.

The computer processing device 110 is also configured to locate data in the extracted information database 122 corresponding to the client institution 130. This located data gets stored in the client questionnaire database 124 alongside the questionnaire answers. In one embodiment, an interview with the client institution 130 is also conducted, and the resulting data is also stored in the client questionnaire database 124. The computer processing device 110 then makes an assessment of the risk that the client financial institution 130 will not be compliant with a set of regulations, based on the data in the client questionnaire database 124. Sets of regulations can include, for example, non-governmental regulations (e.g., self-imposed regulations) or governmental regulations (e.g., USA PATRIOT ACT regulations, or provisions of the Bank Secrecy Act, state, local, or other federal regulations), or nearly any other regulation, standard or best practice (whether self-imposed or otherwise).

In one embodiment, the assessed risk of the client institution 130 is represented by a risk rating value. The risk rating value is a representation of the compliance risk of a institution evaluated across a plurality of categories. In one embodiment, the categories are market environment, economic, political, technological, infrastructure, and personnel. In some embodiments, the relative risk of each of the categories is weighted in order to achieve an overall risk rating value. In one embodiment, market environment risk represents 20% of the risk rating value, economic risk represents 20%, political risk represents 20%, technological risk represents 20%, infrastructure risk represents 10%, and personnel risk represents 10%.

In one exemplary embodiment, in addition to overall risk weighing by category, the individual risk elements within a category are individually weighted. There can be individual risk factors in multiple categories, for example, in market environment (e.g., geographic region, competition factors, dominance in market) or in economic (e.g., earnings, delinquency, regulatory oversight). In one embodiment, because there can exist interrelationships among risk elements between categories, a multiplier is applied to recognize the interrelationships where appropriate. The multiplier can be mathematically quantified, e.g., if 3 of 7 risk factors are a 3 or higher on a 5 point scale, then a 1.2× multiplier is applied. It will be apparent to persons having skill in the relevant art(s) that specific factors may be given higher weighting due to their effect on compliance risk.

In one exemplary embodiment, the computer processing device 110 is also configured to create a set of policies and procedures necessary for the client institution 130 to adopt in order to achieve or maintain compliance with the set of regulations. The set of policies and procedures are stored in the client policy and procedures database 126 and made available to the client institution 130. In one embodiment, the set of policies and procedures is designed to be implemented over the course of one calendar year.

In one exemplary embodiment, the computer processing device 110 provides the client institution 130 with notifications of activities required to perform to achieve/maintain compliance in accordance with the set of policies and procedures. This is beneficial as it allows the client institution 130 to be aware of what is necessary to achieve or maintain compliance without the need of employing an outside provider or a full-time compliance employee to prepare and perform required activities. In one embodiment, the notifications are provided to specific employees of the client institution 130 based on their area of responsibility. Any media generated by the client institution 130 in performing the required activities is stored in client compliance database 128. The types of media generated will be apparent to persons having skill in the art(s), and can include, for example, compliance reports or documents generated by various types of transactions (e.g., loan agreements and other financial transactions, research papers, etc.).

In one exemplary embodiment, the computer processing device 110 evaluates the media stored in the client compliance database 128 for compliance with the set of regulations and provides compliance feedback to the client institution 130. In one embodiment, the computer processing device 110 updates the client questionnaire database 124 based on data obtained from analyzing the client compliance database 128. In other embodiments, the computer processing device 110 reassesses the compliance risk of the client institution 130 based on the updated client questionnaire database 124 and generates a new set of policies and procedures and updates the client policy and procedures database 126 accordingly. In one embodiment, the computer processing device 110 provides the client institution 130 with new notifications based on the updated client policy and procedures database 126. In one embodiment, this process is repeated continually to assist the client institution 130 in achieving and/or maintaining compliance with the set of regulations.

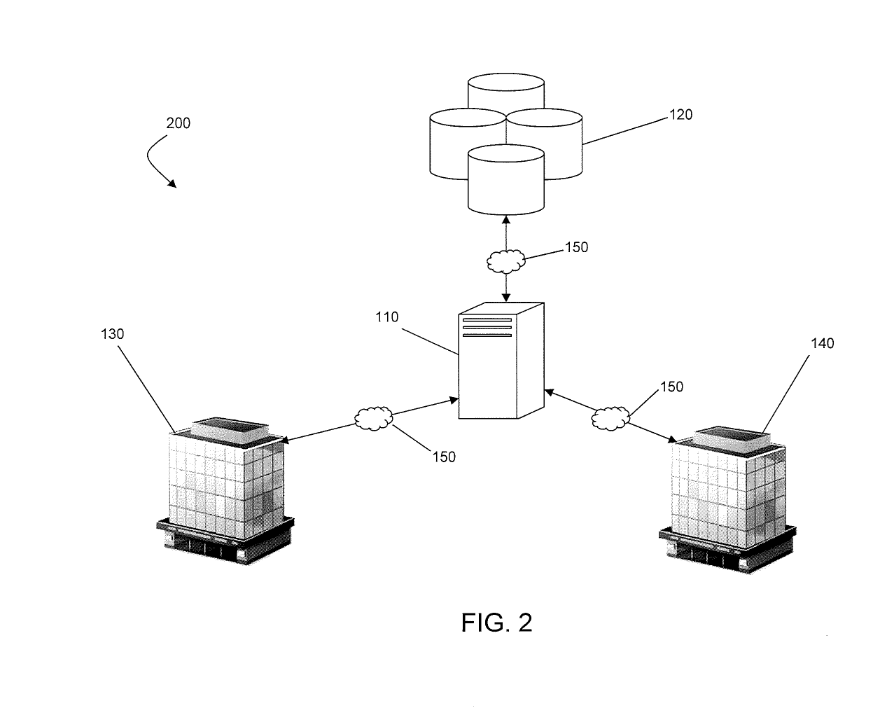

FIG. 2 illustrates a block diagram of an additional exemplary embodiment of the system 100 for assessing compliance risk of an institution. In FIG. 2, the computer processing device 110 is connected to the plurality of databases 120 via the network 150.

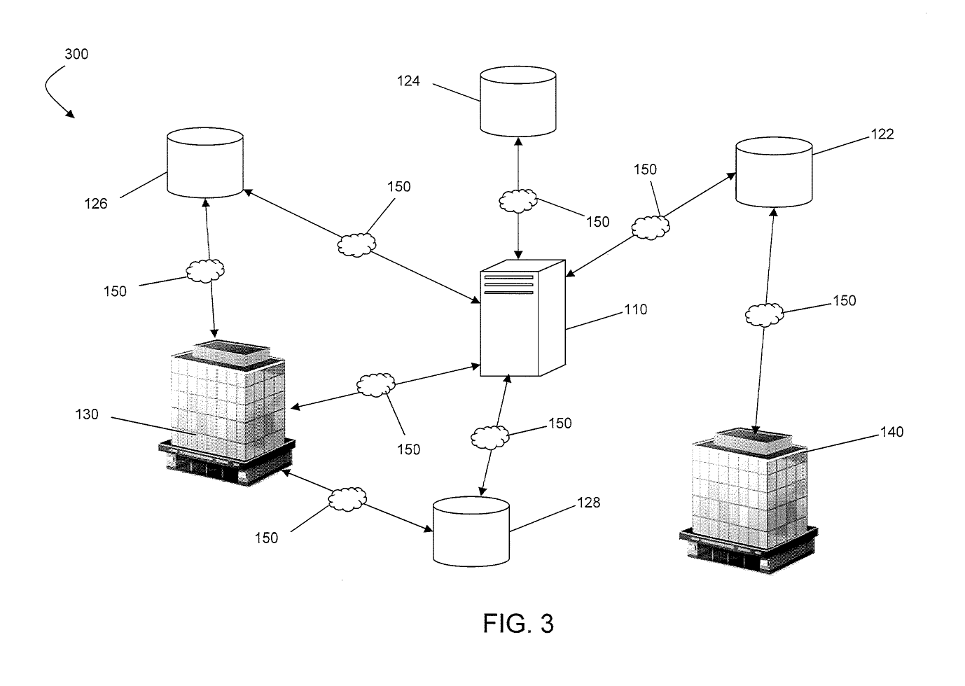

FIG. 3 illustrates a block diagram of another exemplary embodiment of the system 100 for assessing compliance risk of an institution. In FIG. 3, the system 300 for assessing compliance risk is implemented without the use of the plurality of databases 120. Instead, each of the databases are connected in the system 300 separately via the network 150. For example, the extracted information database 122 is connected to the computer processing device 110 and the publicly available source 140.

In the embodiment illustrated in FIG. 3, the client policy and procedures database 126 and the client compliance database 128 are each connected both to the computer processing device 110 and the client institution 130 via the network 150. In this embodiment, it allows for the client institution 130 to, for example, store generated media directly into the client compliance database 128, which can later be accessed by the computer processing device 110 to evaluate for compliance, all via the network 150. In one embodiment, this is implemented by cloud computing.

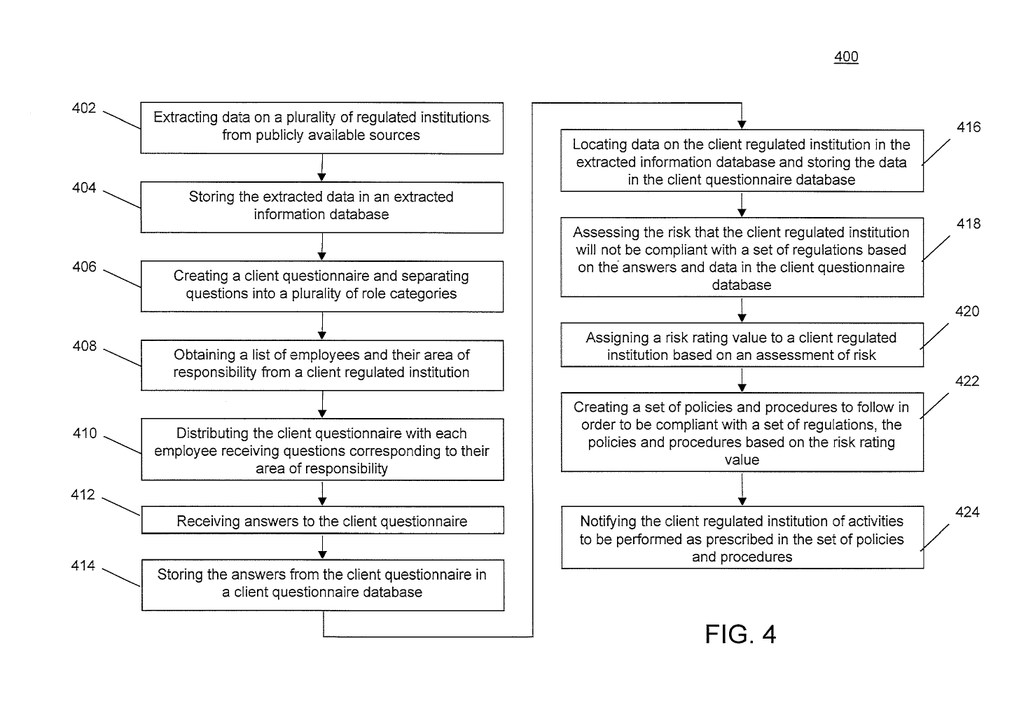

FIG. 4 illustrates a flowchart of a method 400 of assessing compliance risk of a regulated institution.

In step 402, the computer processing device 110 of FIG. 1 extracts data on a plurality of institutions from the publicly available source 130. In one exemplary embodiment, the publicly available source is a regulatory agency. In step 404, the information is stored in the extracted information database 122.

In step 406, the computer processing device 110 creates a client questionnaire and separates questions into a plurality of role categories. In one embodiment, the plurality of role categories includes chief compliance officer, loan lead, deposit lead, advertising lead, and operations lead. In step 408, the computer processing device 110 obtains a list of employees and their area of responsibility from the client institution 130. In step 410, the computer processing device 110 distributes the client questionnaire to the client institution 130 with each employee receiving questions corresponding to their area of responsibility.

In step 412, the computer processing device 110 receives the answers to the client questionnaire and stores them, in step 414, in the client questionnaire database 124. Data on the client institution 130 is located, in step 416, in the extracted information database 122 and stored in the client questionnaire database 124. In step 418, the computer processing device 110 assesses the risk that the client institution 130 will not be compliant with a set of regulations based on the answers and data in the client questionnaire database 124. In some embodiments, the set of regulations are governmental based. For financial institutions, in one embodiment, the set of regulations is the USA Patriot Act and/or the Bank Secrecy Act. For food and drug companies, the set of regulations would include U.S. Food and Drug Agency (FDA) regulations and like agencies around the world. For health care providers, the regulations come from a variety of sources including The Centers for Medicare and Medicaid Services (CMS) for reimbursement.

In step 420, the computer processing device 110 assigns a risk rating value to the client institution 130 based on the assessed compliance risk. In some embodiments, the risk rating value is evaluated as a rating across a plurality of risk categories. In one embodiment, the plurality of risk categories includes market environment, economic, political, technological, infrastructure, and personnel risk. In one embodiment, each risk category includes a plurality of risk elements. In another embodiment, a multiplier is applied to weigh the plurality of risk elements.

In step 422, the computer processing device 110 creates a set of policies and procedures for the client institution 130, based on the institution's risk rating value, to follow to achieve or maintain compliance with the set of regulations and stores the set of policies and procedures in the client policy and procedures database 126. In step 424, the computer processing device 110 notifies the client institution 130 of activities to be performed as prescribed by the set of policies and procedures. In some embodiments, the notification is provided to employees of the client institution 130 based on their area of responsibility.

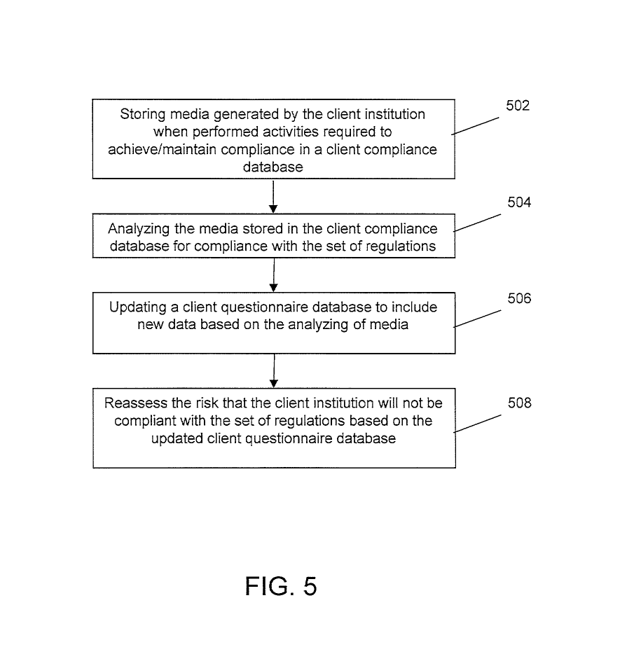

FIG. 5 illustrates a flowchart of additional features to the method 400 for assessing compliance risk of a regulated institution.

In step 502, any media that is generated by the performance activities required to achieve/maintain compliance is stored in the client compliance database 128. The stored media is analyzed, in step 504, for compliance with the set of regulations.

In step 506, the computer processing device 110 updates the data in the client questionnaire database 124 to include data based on the analyzing performed in step 510. Then, in step 514, the computer processing device 110 reassesses the compliance risk of the client institution 130 using the updated client questionnaire database 124. In one embodiment, after reassessing the risk, steps 502 to 514 are repeated.

Where methods described above indicate certain events occurring in certain orders, the ordering of certain events may be modified. Moreover, while a process depicted as a flowchart, block diagram, etc. may describe the operations of the system in a sequential manner, it should be understood that many of the system's operations can occur concurrently. For example, although the computer processing device 110 is disclosed and illustrated (e.g., in FIG. 3) as being configured to receiving and store answers to the client questionnaire prior to locating and storing data extracted from the extracted information database, in some embodiments, the computer processing device 110 can first locate and store the extracted data prior to receiving and storing the answers to the client questionnaire. In other embodiments, the computer processing device 110 can concurrently receive and store both the extracted data and the answers to the client questionnaire.

### Social Networking

In some embodiments, the computer processing device 110 of the system 100 may be configured to provide a social network for client institutions (e.g., the client regulated institution 130). Methods and systems suitable for operating and maintaining a social network will be apparent to persons having skill in the relevant art and may include various web hosting servers operated by or on behalf of the computer processing device 110 and databases, which may be included in the plurality of databases 120. For example, the computer processing device 110 may maintain (e.g., or a third party may maintain on behalf of the computer processing device 110) a website where client institutions 130 may register and connect with other client institutions in the same regulated industry.

The website may include blogs, message boards or forums, or other socially networked features as will be apparent to persons having skill in the relevant art. For example, the website may include a list of regulators or regulatory agencies (e.g., which may be created and/or maintained by the client processing device 110 or by the registered client institutions 130). The client institutions 130 that work with the respective regulators or regulatory agencies may post or share information with other institutions, such as tips or advice regarding compliance and the individual personalities of the specific regulators or agencies. For example, a client institution 130 may share that a specific regulator emphasizes a particular regulation and has a unique style for review of compliance of the regulation, which information may be used by another institution to ensure compliance.

In some instances, client institutions 130 may be required to be invited to a particular social network in order to participate in the social network and share information. In such an instance, the computer processing device 110 may limit the membership in a social network (e.g., creating a “walled garden”), for example, by limiting the number of members in a network or only inviting specific client institutions 130 into the network. Placing such a limitation on membership of the social network may be beneficial for assuring the quality of the information shared in the network, such as by only inviting in client institutions 130 who are considered reliable.

In some embodiments, the computer processing device 110 may mine information in the social network as provided by the client institutions 130, which may be used to improve the sets of policies and procedures created and provided to the client regulated institutions 130. In such an instance, individual client institutions 130 would not need to go through every post in the social network as they could be confident that any useful information provided by other institutions would be taken into account when their set of policies and procedures to follow is created. In instances where membership in a social network may be limited, the computer processing device 110 may be able to mine more accurate and more valuable information more efficiently, as there may be a reduced occurrence of untrustworthy information.

Additional features that may be included in the social network will be apparent to persons having skill in the relevant art. For example, each regulated industry may have a social network unique to that industry, or subpart of an industry demarked in any manner, such as geographically or by zones (geographic or otherwise) of authority or responsibility of an regulatory agency or agencies. In some instances, there may be a separate social network for each regulatory agency or set of regulations. For example, there may be a national or state credit union network, or a drug manufacturer network in a particular country or state. In some embodiments, the social network may be controlled by the institutions themselves, such as an association created or populated by institutions in the regulated industry and/or area.

It will be apparent to persons having skill in the relevant art that the system 100 and method 400 may be used for assessing compliance risk for an institution in any industry that is heavily regulated. In an exemplary embodiment, the regulations may be set forth by multiple regulatory agencies. Such industries may include the financial industry, where the client regulated institution may be a bank, credit union, etc. Other industries may include the pharmaceutical or medical industry, such as a pharmaceutical research company or a medical testing laboratory. Institutions that contract with the federal government, such as defense contractors, etc., may also benefit from the system 100 in order to comply with numerous regulations set forth by the government and other agencies. Additional industries will be apparent to persons having skill in the art, such as the insurance industry (e.g., for certified life underwriting institutions).

Furthermore, while the system 100 may be useful for creating policies and procedures for client institutions to maintain compliance with regulations, it will be apparent to persons having skill in the relevant art that the system 100 may also be used for other services related to regulation, such as reimbursement from regulatory or government agencies. For example, a client medical institution may be provided with instructions and/or guidance for being reimbursed for providing Medicare services by the Center for Medicare & Medicaid Services (CMS), or for modifying business practices to further facilitate compliance or an increase in reimbursement.

The system 100 may be beneficial for smaller institutions, such as locally owned small businesses that may not be able to afford to employ compliance personnel. The system 100 may also be beneficial for larger institutions that, although they can afford to employ compliance personnel, may have a staggering amount of information to review and process in addition to extra or stricter regulations, which may take a significant amount of time even for full-time compliance personnel. The computer processing device 110 and the created set of policies and procedures may be beneficial for saving both small and larger regulated institutions time and expense when maintaining compliance with regulations. In some instances, the computer processing device 110 may be able to provide assistance to the client institution 130 such that it may improve their compliance practice from spending 80% of time looking for compliance issues and 20% of the time fixing any issues, to spending only 20% of the time looking for issues and 80% of the time fixing and/or improving compliance. Furthermore, the review and assistance of an independent party (e.g., the computer processing device 110) may provide additional protection against fraud in instances where an employee of the client institution 130 may not be able to detect compliance issues.

### Artifact Request Distribution

Once the risk rating value for a regulated institution 130 has been identified, the computer processing device 110 may request artifacts from the regulated institution 130 over a predefined period of time in order to reassess compliance and/or evaluate the regulated institution's 130 adherence to policies and/or procedures suggested for the regulated institution 130 to be compliant with the set of regulations. Artifacts may be documents, diagrams, photos, reports, etc. that may be used by the computer processing device 110 to assess risk of the regulated institution 130.

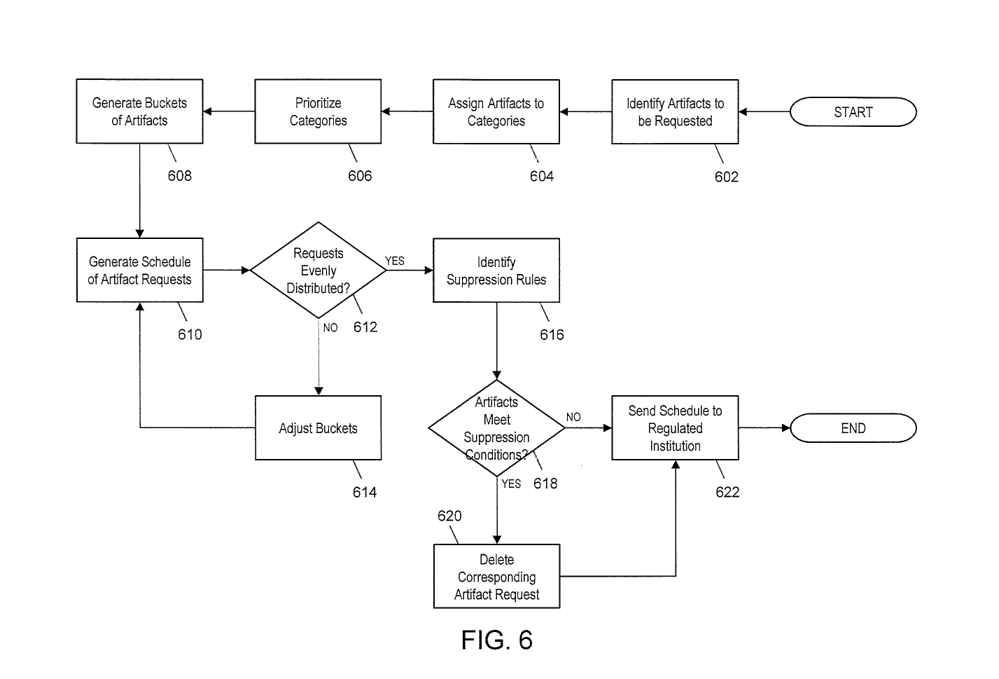

FIG. 6 illustrates a process for distributing requests for artifacts to a regulated institution 130. In step 602, the computer processing device 110 may identify artifacts that are to be requested. Each artifact may have a request frequency and wave. The request frequency may be the frequency at which the artifact is to be produced by the regulated institution 130, such as quarterly, semi-annually, monthly, or annually. The wave may be a grouping of artifacts such that artifacts in the same wave will be requested from the regulated institution 130 before artifacts in the next wave.

In some embodiments, artifacts may also include a weight. The weight may be a numeric value representing a burden of production of the artifact on the regulated institution 130. As discussed below, weights may be used to ensure a minimal impact on the business of the regulated institution 130. In other embodiments, artifacts may also include a group. Weights may also be used in order to order requests for artifacts if the review of one artifact is a precursor to the request of another. For example, weight may dictate the request of specific policy information before artifacts generated from that policy, such that if the policy were to be incorrect (e.g., and thus artifacts generated from that policy also incorrect), the generated artifacts may not be requested. The group may be used if the distribution schedule of artifact requests, discussed below, is adjusted manually such that each artifact assigned to a particular group can be moved (e.g., adjusted in the schedule) together.

In step 604, each of the artifacts may be assigned to a category. Categories may be groupings of artifacts, that, in step 606, are each assigned a priority. The prioritization of the categories may be based on risk. In some instances, the prioritization of categories, and assignment of artifacts to particular categories, may be based on the risk rating value or a value of one or more risk categories of the particular regulated institution 130. For example, if the regulated institution 130 has high risk for a particular risk category, artifacts related to that risk category may be assigned to a category that receives a higher priority.

In step 608, the computer processing device 110 may generate buckets of artifacts. Each bucket may contain all artifacts of a particular category that have the same wave. The buckets may then be ordered based on the priority of the corresponding categories, as broken into waves. In step 610, a schedule of artifact requests may be generated for the bucketed artifacts based on the corresponding category priority and wave distribution. The schedule may also be generated such that the artifact requests are spread out (e.g., as grouped into buckets) over a predefined period of time. The spreading out of the artifact requests may minimize the burden of product on the regulated institution 130, which may result in compliance with the set of regulations with less time and effort required of the regulated institution 130 as compared to traditional systems and methods for assessing and achieving compliance.

In step 612, the computer processing device 110 may identify if the artifact requests are evenly distributed. Even distribution of the artifact requests may be based on at least one of: number of the requests, overall weight of the requests, adjustments based on times that should be removed from reconsideration (e.g., holidays), and additional criteria that will be apparent to persons having skill in the relevant art. If the requests are not evenly distributed, then, in step 614, the computer processing device 110 may adjust the buckets as to evenly distribute the request. Adjusting the buckets may include expanding or reducing the number of buckets, combining buckets (e.g., adjacent buckets with the lowest burden to the client), adjusting the time schedule, etc. Once the buckets have been adjusted, the schedule may be regenerated and evaluated again for even distribution.

Once the schedule has been generated and results in an even distribution of artifact requests, then, in step 616, the computer processing device 110 may identify suppression rules to be applied to the artifact requests. Suppression rules may be rules that evaluation to a condition that may be used to trigger the removal of an artifact from a request. The suppression rules may be checked against existing client facts (e.g., as available in the databases 120, from the publicly available information 140, etc.) to determine if a particular artifact request should be sent to the regulated institution 130 or not. For example, a suppression rule may include a condition that a particular artifact request may not need to be sent to a regulated institution 130 if the institution is located in a particular municipality, or if the institution is a specific type of institution, such as a credit union.

In step 618, the computer processing device 110 may determine if any of the artifacts meet any suppression conditions. If one or more of the artifacts do meet any of the conditions, then, in step 620, the computer processing device 110 may delete the corresponding artifact request or requests from the request distribution schedule. In step 622, the finalized schedule may be sent to the regulated institution 130.

The regulated institution 130 may then provide the requested artifacts to the computer processing device 110 over the course of the predefined period of time. The computer processing device 110 may receive the artifacts and then may reassess the risk rating value of the regulated institution 130 based on the data included in the provided artifacts, such as by using the systems and methods discussed above. In some embodiments, the computer processing device 110 may generate a new artifact request schedule based on the reassessed risk rating value, and then may send the new schedule on to the regulated institution 130. In such an instance, the computer processing device 110 may be able to continually adapt the risk rating value and artifact request schedule to ensure that the regulated institution 130 is compliant with the set of regulations quickly and efficiently.

In some instances, the computer processing device 110 may develop a remediation plan for the regulated institution 130 to observe, such as for identifying their progress in one or more risk categories. The remediation plan may be generated based on a remediation task list, which may be created using observations, rationales, received artifacts, questionnaire responses, or any other suitable data that will be apparent to persons having skill in the relevant art. The remediation task list may be a series of tasks which, when executed by the client regulated institution 130, are meant to cure a regulatory defect or deficiency. The task list may also be distributed to the client regulated institution 130 such that the regulated institution 130 would be able to assign tasks to roles (e.g., employees, etc.), which could provide for stronger progress monitoring.

In one instance, the remediation task list may correspond to or have commonality with the artifact request schedule (e.g., some remediation tasks may be artifact requests). In one embodiment, the computer processing device 110 may generate a report based on the remediation plan, which could be presented to a regulator to show the progress of the regulated institution 130 for compliance. In some embodiments, the remediation tasks included in the remediation plan may be weighted, such as based on the severity of the underlying defect. In such an instance, the client regulated institution 130 would be able to prioritize the implementation of the remediation plan based on the weights of the underlying tasks. In some instances, remediation plans themselves may be similarly weighted.

The remediation plan may also be used to provide real-time alerts of information to the regulated institution 130. For example, the regulated institution 130 may receive an alert when their compliance status changes for a particular risk category (e.g., from a red level to a yellow level, from a yellow level to a green level, etc.). Alerts may also be used as part of the distribution of artifact requests, such as, for example, alerting the regulated institution 130 when a particular artifact is due or when an action may be necessary (e.g., the beginning of capturing data) for a particular artifact.

Such times may also be recorded on a calendar, which may illustrate to the regulated institution when artifact request deadlines occur, when and why compliance ratings moved and by how much, when important changes in regulations may take effect, etc. The calendar or calendars may be made available to the regulated institution 130 and may, in some embodiments, be programmed in or be capable of exporting to one or more traditional calendar programs, such as Microsoft® Outlook™.

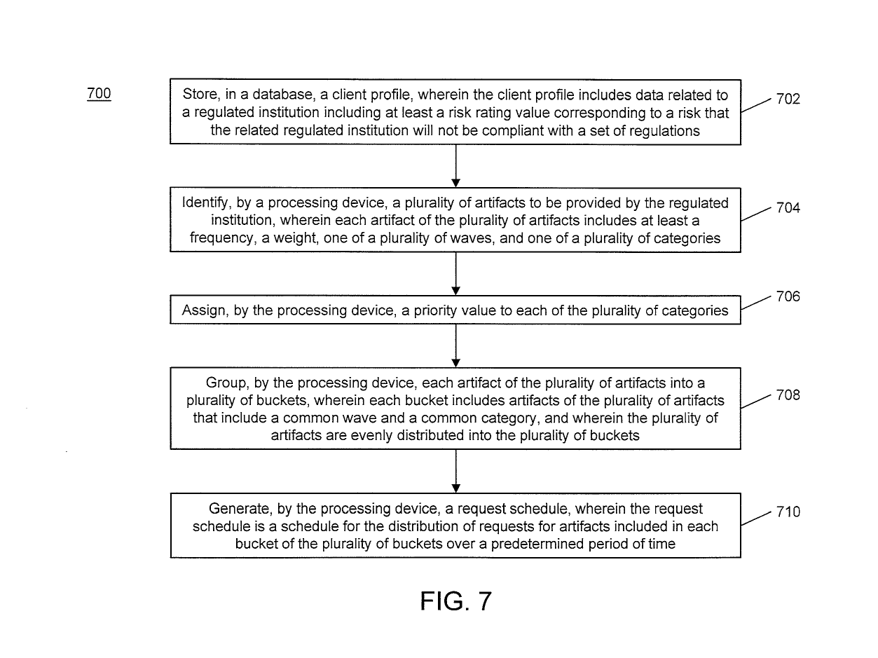

FIG. 7 shows an exemplary method 700 for distributing artifacts to a regulated institution (e.g., the regulated institution 130) for risk assessment.

In step 702, a client profile may be stored in a database (e.g., the client compliance database 128), wherein the client profile includes data related to a regulated institution 130 include at least a risk rating value corresponding to a risk that the related regulated institution 130 will not be compliant with a set of regulations.

In step 704, a processing device (e.g., the computer processing device 110) may identify a plurality of artifacts to be provided by the regulated institution 130, wherein each artifact of the plurality of artifacts may include at least a frequency, a weight, one of a plurality of waves, and one of a plurality of categories. In one embodiment, the frequency may be at least one of: quarterly, semi-annually, monthly, and annually. In some embodiments, the weight may be a numeric value corresponding to a burden of product of the associated artifact on the regulated institution 130.

In step 706, the processing device 110 may assign a priority value to each of the plurality of categories. In step 708, the processing device 110 may group each artifact of the plurality of artifacts into a bucket of a plurality of buckets, wherein each bucket includes artifacts that include a common wave and a common category and where the artifacts are evenly distributed into the plurality of buckets.

In step 710, the processing device 110 (e.g., or a scheduling device as part of the computer processing device 110) may generate a request schedule, wherein the request schedule is a schedule for the distribution of requests for artifacts included in each bucket of the plurality of buckets over a predetermined period of time. In one embodiment, generating the schedule may include scheduling buckets with a higher priority value ahead of buckets with a lower priority value. In some embodiments, the schedule may be generated such that requests for artifacts are evenly distributed during the predetermined period of time. In embodiments where the weight of an artifact corresponds to a burden of product, the schedule may be generated based on the weights of the artifacts included in each of the buckets.

In one embodiment, the method 700 may further include transmitting, by a transmitting device of the computer processing device 110, the requests for artifacts to the regulated institution 130 based on the generated request schedule. In a further embodiment, the method 700 may also include receiving, by a receiving device of the computer processing device 110, a plurality of supplied artifacts in response to the transmitted requests for artifacts, and updating, by the processing device 110, the risk rating value associated with the regulated institution 130 based on the received plurality of supplied artifacts.

In another embodiment, the method 700 may further include identifying, by the processing device 110, at least one artifact of the plurality of artifacts that meets at least one of a plurality of predefined suppression conditions based on compliance data associated with the regulated institution 130, and removing, from the plurality of artifacts, the identified at least one artifact.

### Report Generation

The computer processing device 110 may be configured to generate reports based on the information discussed above. For example, the computer processing device 110 may generate reports based on risk corresponding to one or more risk categories, the risk rating value, the remediation plan, supplied artifacts, questionnaire responses, etc. In some embodiments, the computer processing device 110 may generate reports by presenting a series of well-defined choices that match up to a set of observable criteria, then linking these criteria to a specific output. For example, the output may be a rationale as to why the underlying observational finding is valuable from a risk rating point of view.

In order to generate the report, a user (e.g., of the computer processing device 110, an employee of the regulated institution 130, etc.) may provide an answer to a question regarding an observation. The answer may then lead to the asking of an additional question, of the publishing of the answer and/or a rationale related to the answer. The answer may be published to an answer listener, which may be used to do at least one of: create an observation based on the answer, create a rationale based on the answer, define a fact about the client based on the answer, trigger the asking of additional questions, prevent particular questions from being presented, and keep a running total score based on the answer given.

The above reporting may be applied to a user questionnaire, such as one answered by an employee of the regulated institution 130. Once the questionnaire is completed, an algorithm may be applied to merge client facts from disparate sources, including facts created by the questionnaire, and use these facts to create a set of generic observations related to the particular asserted fact as well as a rationale as to why the fact is important from a regulatory perspective. The algorithm may rank observations based on importance and publish a configurable amount of the observations and their matching rationales as a work paper. The computer processing device 110 may combine known facts about the regulated institution 130, observations, and scores from the answers to product an actionable work paper, which may facilitate regulatory compliance.

The client facts may be any facts related to the regulated institution 130 that may be obtained from a variety of sources. The facts may be defined at a client type level and represent what the computer processing device 110 may be used for intelligent decision making, guided artifact scoring, guided questionnaire, and onsite visitation. The facts may come from sources such as published institution regulatory data, the self-assessment questionnaires, artifact reviews, any system activity, etc. The facts may also be aggregated across institutions based on national, regional, local, size, or other criteria, and may be used to provide syndication data. In some embodiments, the client facts may expire periodically, such as to reflect that regulated institutions engage in changing business practices. In such an embodiment, expired client facts may be renewed or recreated if applicable.

Such reporting mechanisms as discussed above may also be used by the computer processing device 110 for the generation of reports on compliance via system-generated templates. For example, a user may review information regarding the compliance with the set of regulations by the regulated institution 130, such as artifacts provided by the regulated institution 130 in response to an artifact request. The user may look for specific information, markers, numbers, or other such data from the artifact and check off boxes regarding the existence or non-existence of such information as indicated by each box. With each check, the system may generate a specific observation or other passage based thereon, which may be used to populate a report. The report may then be reviewed by a senior reviewer. The senior reviewer may check for accuracy, make necessary changes, append pertinent information, etc. The report may then be published, which may be made available to the regulated institution 130, a regulator, etc.

In such a system, users may be able to systematically review information for the development of thorough reports without the need for the users to examine each artifact in-depth. A single senior reviewer may also be able to review the reporting of a number of users, effectively allowing for significantly more efficient reporting that can be both quicker and more cost effective for both the computer processing device 110 and the regulated institution 130.

Guided scoring may also be used by the computer processing device 110 as part of the report generation and/or automatic generation of review work. Guided scoring may be a process of using client facts and responses to other questions in the scoring mechanism to generate a relevant set of questions. For example, a user response to a particular question may yield additional (or the removal of) questions. In addition, the computer processing device 110 may associate a series of observations (e.g., triggered by specific responses to questions) and rationales (e.g., statements as to why the observation is important) with a particular answer to a question. This may result in the automatic generation of reports, such as when using system-generated templates.

In addition, the computer processing device 110 may also weight the importance of a particular question within the guided review to facilitate automated scoring of the underlying artifact, in addition to the review narrative. Client facts and remediation tasks and/or a remediation plan may also be automatically created based on question responses. In some instances, a remediation task and/or plan may be geared towards fixing an underlying defect or deficiency indicated by the particular question response. The automated generation of these facts, plans, and reports may result in a significantly faster and more efficient process for the client regulated institution 130 to achieve and maintain compliance with the set of regulations.

Techniques consistent with the present disclosure provide, among other features, systems and methods of assessing compliance risk of a regulated institution. While various exemplary embodiments of the disclosed system and method have been described above, it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope. The scope of the invention is defined by the claims and their equivalents.

What is claimed is:

1. A method for distributing requests for artifacts to a regulated institution for risk assessment, comprising:
storing, in a database, a client profile, wherein the client profile includes data related to a regulated institution including at least a risk rating value corresponding to a risk that the related regulated institution will not be compliant with a set of regulations;
identifying, by a processing device, a plurality of artifacts to be provided by the regulated institution, wherein each artifact of the plurality of artifacts includes at least a frequency, a weight, one of,a plurality of waves, and one of a plurality of categories;
assigning, by the processing device, a priority value to each of the plurality of categories;
grouping, by the processing device, each artifact of the plurality of artifacts into a plurality of buckets, wherein each bucket includes artifacts of the plurality of artifacts that include a common wave and a common category, and wherein the plurality of artifacts are evenly distributed into the plurality of buckets; and
generating, by the processing device, a request schedule, wherein the request schedule is a schedule for the distribution of requests for artifacts included in each bucket of the plurality of buckets over a predetermined period of time.

2. The method of claim 1, further comprising:
transmitting, by a transmitting device, the requests for artifacts to the regulated institution based on the generated request schedule.

3. The method of claim 2, further comprising:
receiving, by a receiving device, a plurality of supplied artifacts in response to the transmitted requests for artifacts; and
updating, by the processing device, the risk rating value associated with the regulated institution based on the received plurality of supplied artifacts.

4. The method of claim 1, further comprising:
identifying, by the processing device, at least one artifact of the plurality of artifacts that meets at least one of a plurality of predefined suppression conditions based on compliance data associated with the regulated institution; and
removing, from the plurality of artifacts, the identified at least one artifact.

5. The method of claim 1, wherein the schedule for the distribution of requests is generated such that the requests for artifacts are evenly distributed during the predetermined period of time.

6. The method of claim 1, wherein generating the request schedule includes scheduling buckets with a higher priority value ahead of buckets with a lower priority value.

7. The method of claim 1, wherein the frequency is at least one of: quarterly, semi-annually, monthly, and annually.

8. The method of claim 1, wherein the weight is a numeric value corresponding to a burden of production of the associated artifact on the regulated institution.

9. The method of claim 8, wherein generating the request schedule includes scheduling buckets based on the weights included in the included artifacts of the plurality of artifacts.

10. A system for distributing artifacts to a regulated institution for risk assessment, comprising:
a database configured to store a client profile, wherein the client profile includes data related to a regulated institution including at least a risk rating value corresponding to a risk that the related regulated institution will not be compliant with a set of regulations;
a processing device configured to
identify a plurality of artifacts to be provided by the regulated institution, wherein each artifact of the plurality of artifacts includes at least a frequency, a weight, one of a plurality of waves, and one of a plurality of categories,
assign a priority value to each of the plurality of categories, and
group each artifact of the plurality of artifacts into a plurality of buckets, wherein each bucket includes artifacts of the plurality of artifacts that include a common wave and a common category, and wherein the plurality of artifacts are evenly distributed into the plurality of buckets; and
a scheduling device configured to generate a request schedule, wherein the request schedule is a schedule for the distribution of requests for artifacts included in each bucket of the plurality of buckets over a predetermined period of time.

11. The system of claim 10, further comprising:
a transmitting device configured to transmit the requests for artifacts to the regulated institution based on the generated request schedule.

12. The system of claim 11, further comprising:
a receiving device configured to receive a plurality of supplied artifacts in response to the transmitted requests for artifacts, wherein
the processing device is further configured to update the risk rating value associated with the regulated institution based on the received plurality of supplied artifacts.

13. The system of claim 10, wherein
the processing device is further configured to
identify at least one artifact of the plurality of artifacts that meets at least one of a plurality of predefined suppression conditions based on compliance data associated with the regulated institution, and
remove, from the plurality of artifacts, the identified at least one artifact.

14. The system of claim 10, wherein the schedule for the distribution of requests is generated such that the requests for artifacts are evenly distributed during the predetermined period of time.

15. The system of claim 10, wherein generating the request schedule includes scheduling buckets with a higher priority value ahead of buckets with a lower priority value.

16. The system of claim 10, wherein the frequency is at least one of: quarterly, semi-annually, monthly, and annually.

17. The system of claim 10, wherein the weight is a numeric value corresponding to a burden of production of the associated artifact on the regulated institution.

18. The system of claim 17, wherein generating the request schedule includes scheduling buckets based on the weights included in the included artifacts of the plurality of artifacts.
